(19) United States
(12) Patent Application Publication
(10) Pub. No.: US 2008/0018259 A1
(43) Pub. Date: Jan. 24, 2008

(54) Mirror having a field emission information display

(76) Inventor: Kuei Wen Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/490,048

(22) Filed: Jul. 21, 2006

(51) Int. Cl. G09G 3/10

(52) U.S. Cl. 315/169.3

(57) ABSTRACT

A mirror having a field emission information display includes a semitransmitting reflecting mirror body, a field emission unit, and a control unit. The field emission unit is installed in the semitransmitting reflecting mirror body. The field emission unit includes an anode structure having an anode layer, a cathode structure having a cathode layer that corresponds to the anode structure, and an insulating structure located between the anode structure and the cathode structure to form a specified gap. The control unit is installed in the semitransmitting reflecting mirror body and is connected with the field emission unit for controlling the field emission unit to display information images. Thereby, a plate lighting display image area or a lighting area is formed on the semitransmitting reflecting mirror body.

### BACKGROUND OF THE INVENTION

1. Field of the Invention

The present invention relates to a mirror having a field emission information display. In particular, this invention relates to a mirror having a field emission information display that combines a field emission unit and a semitransmitting reflecting mirror. The information image generated on the mirror has a field emission information display that is detailed and colorful.

2. Description of the Related Art

As technology has been rapidly developing, the requirements for displays have increased. The display has changed from cathode-ray tubes (CRT) to liquid crystal displays (LCD). Currently, field emission displays are also being developed. Field emission displays (FEDs) makes a CRT flatter and thinner. The displaying principle of an FED is similar to that of a CRT. Both emit electrons from the cathode. The electrons pass through a vacuum and are accelerated by the anode to excite fluorescence to light. The fluorescence used for a CRT is the same as that of an FET. The main difference is the generating method of the electrons. Standard CRTs generate electrons by heating the cathode. An FET however, absorbs the electrons from the cathode via an electric field. Therefore, the FED is more suitable to be a display used for a variety of devices.

Reference is made to FIG. 1, which shows a schematic diagram of an FED 1a of the prior art. The FED 1a includes an anode 3a and a cathode 4a. A unit structure 5a includes a unit anode 51a and a unit cathode 52a. A rib 53a is located between the unit anode 51a and the unit cathode 52a to form a vacuum area between the anode 3a and the cathode 4a and support the anode 3a and the cathode 4a. The anode 3a includes an anode substrate 31a, an anode conducting layer 32a, and a fluorescence powder layer 33a. The cathode 4a includes a cathode substrate 41a, a cathode conducting layer 42a, and an electron emission layer 43a. The rib 53a is located between the anode 3a and the cathode 4a to form a vacuum. Next, an external electrical field is provided to make the electron emission layer 43a of the cathode 4a generate electrons. The electrons are emitted to the fluorescence powder layer 33a of the anode 3a so that the fluorescence powder layer 33a is excited to light.

### SUMMARY OF THE INVENTION

One particular aspect of the present invention is to provide a mirror having a field emission information display. The present invention combines two polar structures of a field emission unit with a semitransmitting reflective mirror so that the brightness of information generated on the semitransmitting reflecting mirror is greater than 300 cd/m². Therefore, the information image is detailed and colorful. The mirror having a field emission information display can be used in indoor public places or household activities, such as for a mirror lamp, an emergency lamp, a night lamp, or for displaying information, etc.

The mirror having a field emission information display of the present invention includes a semitransmitting reflecting mirror body, a field emission unit, and a control unit. The field emission unit is installed in the semitransmitting reflecting mirror body. The field emission unit includes an anode structure having an anode layer, a cathode structure having a cathode layer that corresponds to the anode structure, and an insulating structure located between the anode structure and the cathode structure to form a specified gap. The control unit is installed in the semitransmitting reflecting mirror body and is electrically connected with the field emission unit for controlling the field emission unit to display information. Thereby, a flat lighting image-displaying area or a lighting area is formed on the semitransmitting reflecting mirror body.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the mirror having a field emission information display of the prior art;

FIG. 2 is a schematic diagram of the field emission unit of the mirror having a field emission information display of the present invention;

FIG. 3 is a cross-sectional view of the mirror having a field emission information display of the present invention;

FIG. 4 is a block diagram of the mirror having a field emission information display of the present invention;

FIG. 5 is a block diagram of the driving circuit module of the mirror having a field emission information display of the present invention;

FIG. 6 is a block diagram of the power circuit module of the mirror having a field emission information display of the present invention;

FIG. 7 is a block diagram of the feedback circuit module of the mirror having a field emission information display of the present invention; and

FIG. 8A is a perspective view of the mirror having a field emission information display of the present invention having a displaying function;

FIG. 8B is a perspective view of the mirror having a field emission information display of the present invention having another displaying function; and

FIG. 8C is a perspective view of the mirror having a field emission information display of the present invention without any displaying function.

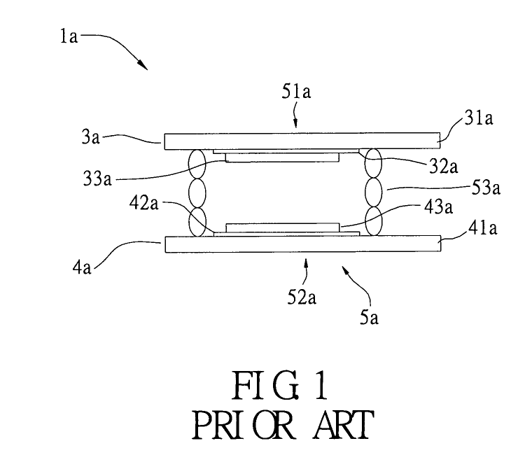

### DETAILED DESCRIPTION OF THE PREFERRED EMBODIMENTS

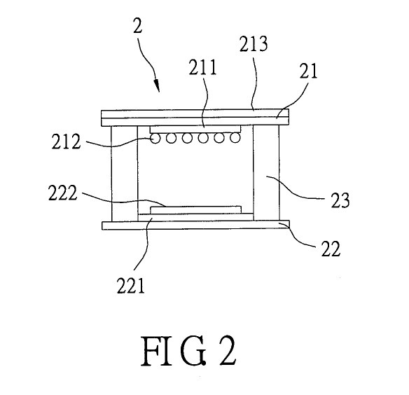

Reference is made to FIG. 2, which shows a schematic diagram of the field emission unit of a mirror having a field emission information display of the present invention. The field emission unit 2 includes an anode structure 21, a cathode structure 22 corresponding to the anode structure 21, and an insulating structure 23 located between the anode structure 21 and the cathode structure 22 to form a specified gap. The specified gap can be between 40˜100 μm. The preferred embodiment is 50˜70 μm. The anode structure 21 has an anode conducting layer 211, and an anode layer 212 located above the anode conducting layer 211. The cathode structure 22 has a cathode conducting layer 221, and a cathode layer 222 located above the cathode conducting layer 221. The anode layer 212 is a fluorescent layer. The cathode layer 222 is an emission layer. The emission layer can be a carbon nanotube layer or a tiny metal pointed layer. The cathode layer 222 is a carbon nanotube layer formed by coating or screen printing by electrophoresis. The thickness of the anode layer 212 is within a specified range. The thickness of the anode layer 212 can be between 2˜10 μm. The preferred embodiment is 4˜8 μm. The thickness of the cathode layer 222 is also within a specified range. The thickness of the cathode layer 222 can be between 1˜20 μm. The preferred embodiment is between 5˜10 μm.

Furthermore, the anode structure 21 further combines with a reflecting layer 213. The reflecting layer 213 is located on a side of the anode structure 21 that is opposite to the anode conducting layer 211. The reflecting layer 213 combines a metal material (such as aluminum) on the anode structure 21 via an evaporation method. Alternatively, the reflecting layer 213 is combined with the anode structure 21 via a pasting-film method. The reflecting layer 213 enhances the brightness of the displaying information.

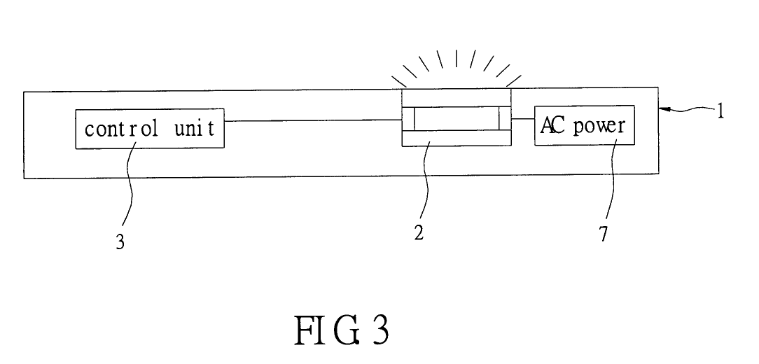

Reference is made to FIG. 3, which shows a cross-sectional view of the mirror having a field emission information display of the present invention. The mirror having a field emission information display of the present invention includes a field emission unit 2 installed in the semitransmitting reflecting mirror body 1, a control unit 3 electrically connected with the field emission unit 2, and an AC power 7 electrically connected with the field emission unit 2. The control unit 3 controls the field emission unit 2 to generate an information image on a surface of the semitransmitting reflecting mirror body 1. The AC power 7 makes the displayed information image more dynamic.

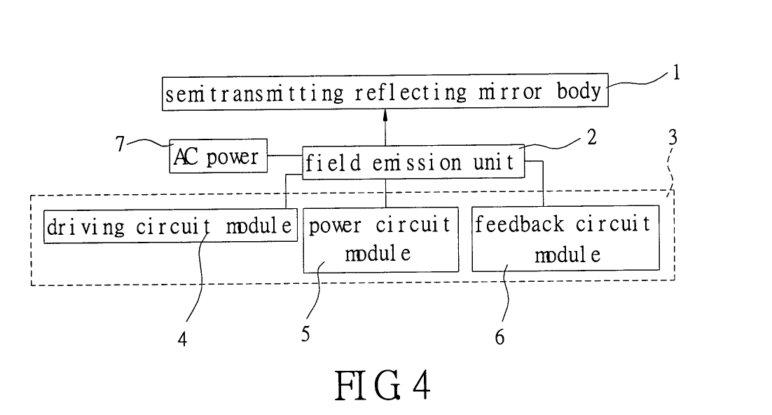

Reference is made to FIG. 4, which shows a block diagram of the mirror having a field emission information display of the present invention. The mirror having a field emission information display includes a semitransmitting reflecting mirror body 1, a field emission unit 2, a control unit 3, and an AC power 7. The control unit 3 is electrically connected with the field emission unit 2 to control the information display of the field emission unit 2. The control unit 3 includes a driving circuit module 4, a power circuit module 5, and a feedback circuit module 6. The driving circuit module 4 controls the field emission unit 2 to light and display images, texts, and figure patterns. The power circuit module 5 controls and increases the current density of the field emission unit 2. The power circuit module 5 also increases the lighting efficiency, and prevents the field emission unit 2 from over-heating so that the life of the field emission unit 2 is lengthened. The feedback circuit module 6 evens out the brightness of the field emission unit 2 so that it is uniform. The AC power 7 is electrically connected with the field emission unit 2. The AC power 7 cooperates with the driving circuit module 4 to make the field emission unit 2 dynamically display the information image.

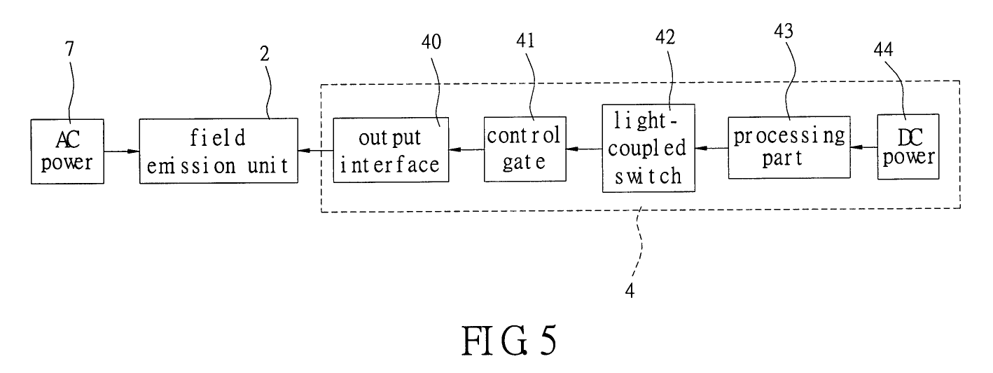

Reference is made to FIGS. 5 and 2. FIG. 5 shows a block diagram of the driving circuit module of the mirror having a field emission information display of the present invention. The driving circuit module 4 includes an output interface 40 connected with the cathode structure 22 of the field emission unit 2, at least one control gate 41 connected with the output interface 40, at least one light-coupled switch 42 connected with the control gate 41, and a processing part 43 connected with the light-coupled switch 42. The processing part 43 is connected with a DC power 44, and provides the power required by the processing part 43. The processing part 43 processes the digital data or program data stored in the inner data register. After the data has been processed, a control signal is outputted and transmitted to the light-coupled switch 42. The control signal drives the light-coupled switch 42, and controls the control gate 41 connected with the light-coupled switch 42. The light-coupled switch 42 separates and protects the processing part 53. The control gate 41 is connected with the cathode structure 22 of the field emission unit 2 via the output interface 40 so as to control the cathode structure 22 to be grounded or floated. The control gate 41 is composed of at least one logic switch. The logic switch can be a CMON logic switch, a NMOS logic switch, or a TTL logic switch.

The anode structure 21 of the field emission unit 2 is connected with an AC power 7. When the cathode structure 22 of the field emission unit 2 is grounded, the cathode layer 25 (emission layer) of the cathode structure 22 generates electrons, and the electrons are accelerated by the AC power 7 located between the anode structure 21 and the cathode structure 22 to excite the anode layer (fluorescent layer) 24 located above the anode structure 21 to light. The insulating structure 23 located above the cathode structure 22 separates the electrons generated between the cathode layers 25 to prevent the electrons from disturbing each other.

When the control gate 41 controls the cathode structure 22 to be floated, the driving electric field between the anode structure 21 and the cathode structure 22 is inactive. The electrons cannot be generated from the cathode structure 22. Therefore, the field emission unit 2 cannot light or display information.

Because the anode structure 21 of the field emission unit 2 is connected with the AC power 7, the field emission unit 2 will light and display when the AC power 7 is a positive electric field and the cathode structure 22 of the field emission unit 2 is grounded. Alternatively, when the cathode structure 22 of the field emission unit 2 is floated, the field emission unit 2 cannot light or display information. Therefore, by connecting the anode structure 21 with a high frequency AC power 7 and controlling the cathode structure 22 to be grounded or floated, the field emission unit 2 can dynamically display the image.

When the AC power 7 is in a negative electric filed, the electric charge accumulated at the anode part 21 is released. Therefore, the heat generated during the continuous lighting process is reduced so that the usage life of the mirror having a field emission information display is extended. The AC power 7 is a high frequency and high voltage AC power.

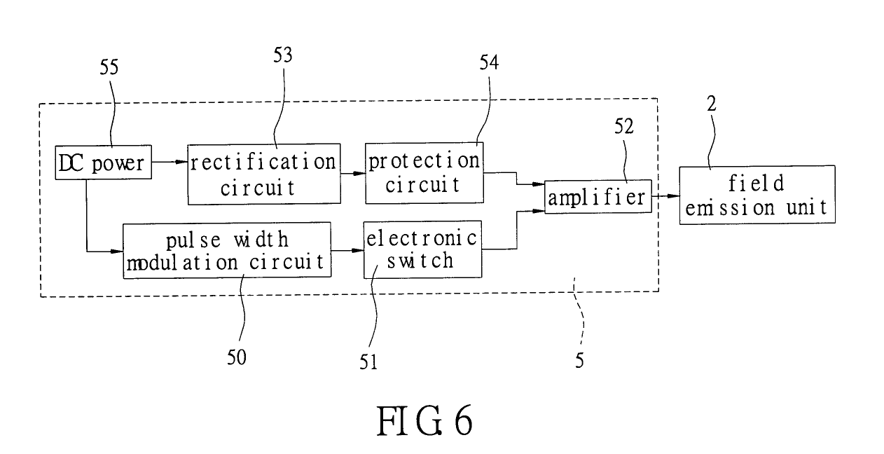

Reference is made to FIG. 6, which shows a block diagram of the power circuit module of the mirror having a field emission information display of the present invention. The power circuit module 5 includes a pulse width modulation circuit 50 connected with a DC power 55, an electronic switch 51 connected with the pulse width modulation circuit 50, an amplifier 52 connected with the DC power 55 and the electronic switch 51, a rectification circuit 53 connected with the DC power 55 and the amplifier 52, and a protection circuit 54 connected with the DC power 55 and the amplifier 52. The DC power 55 is connected with the rectification circuit 53 and the pulse width modulation circuit 50 for providing the power required for the field emission unit 2. The rectification circuit 53 boosts the voltage of the DC power 55, and is connected with the protection circuit 54. The protection circuit 54 is used for preventing the circuit from being over-voltage and over-current. The pulse width modulation circuit 50 is connected with the electronic switch 51, and generates a modulation signal according to the DC power 55 so as to control the electronic switch 51 for switching power. The amplifier 52 is connected with the protection circuit 54 and the electronic switch 51. The amplifier 52 amplifies the boosted DC power 55 to generate high frequency and intermittence power according to the high frequency power switching operation of the electronic switch 51, and the high frequency and intermittence power is provided to the field emission unit 2. The amplifier 52 is a high frequency transformer.

Reference is also made to FIG. 2. One end of the amplifier 52 is connected with the anode structure 21 of the field emission unit 2, and another end of the amplifier 62 is connected with the cathode structure 22 of the field emission unit 2 to provide the AC power required for the field emission unit 2. Therefore, via a high voltage and a high frequency AC power, the lighting efficiency of the field emission unit 2 increases, and prevents the field emission unit 2 from over-heating so as to lengthen the life of the field emission unit 2.

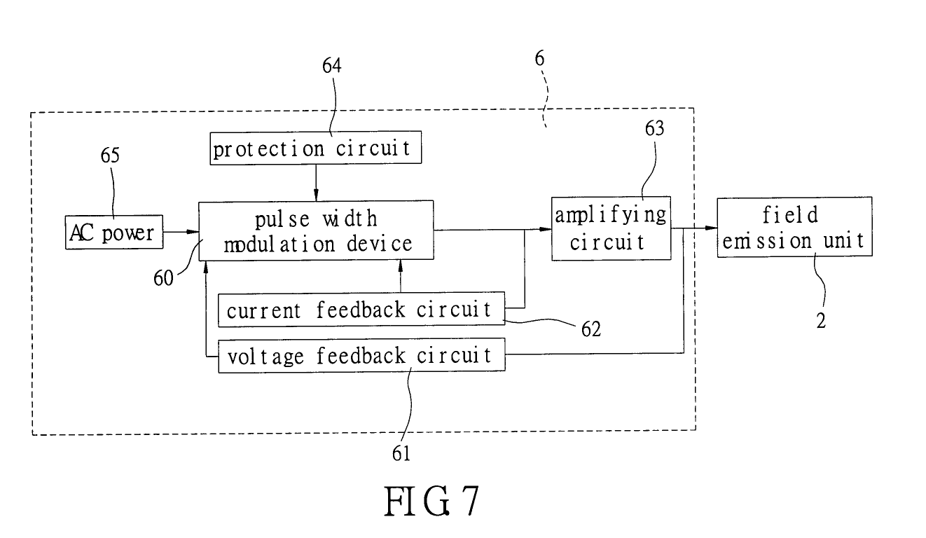

Reference is made to FIG. 7, which shows a block diagram of the feedback circuit module of the mirror having a field emission information display of the present invention. The feedback circuit module 6 includes a pulse width modulation device 60 connected with a DC power 65 for converting the DC power 65 into an AC power, a voltage feedback circuit 61 connected between the pulse width modulation device 60 and the field emission unit 2, a current feedback circuit 62 connected between the pulse width modulation device 60 and the field emission unit 2, an amplifying circuit 63 connected between the pulse width modulation device 60 and the field emission unit 2, and a protection circuit 64 connected with the pulse width modulation device 60. The voltage feedback circuit 61 is used for feeding back a voltage signal. The current feedback circuit 62 is used for feeding back a current signal. The pulse width modulation device 60 detects the voltage signal and the current signal to adjust the level of the AC power. The pulse width modulation device 60 is controlled by an integrated circuit. The protection circuit 74 protects the feedback circuit so as to prevent the circuit from being burned out.

The front stage of the amplifying circuit 63 is connected with the pulse width modulation device 60 to form the current feedback circuit 62 for feeding back the AC current and forming a stable closed loop. After the AC current is fed back to the pulse width modulation device 60, the pulse width modulation device 70 detects the signal level of the feedback AC current. When the level of the feedback signal is distorted, the current density of the field emission unit 2 is affected. At this moment, the pulse width modulation device 60 compensates for the level of the feedback signal to even out the current density of the field emission unit 2. Therefore, the uniform brightness of the information image displayed on the field emission unit 2 is assured.

The back stage of the amplifying circuit 63 is connected with the pulse width modulation device 60 to form the voltage feedback circuit 61 for feeding back the AC voltage and forming a stable closed loop. The pulse width modulation device 60 compensates for the feedback AC voltage so that the brightness of the information image displayed on the field emission unit 2 is adequate, and the brightness of the information image is uniform.

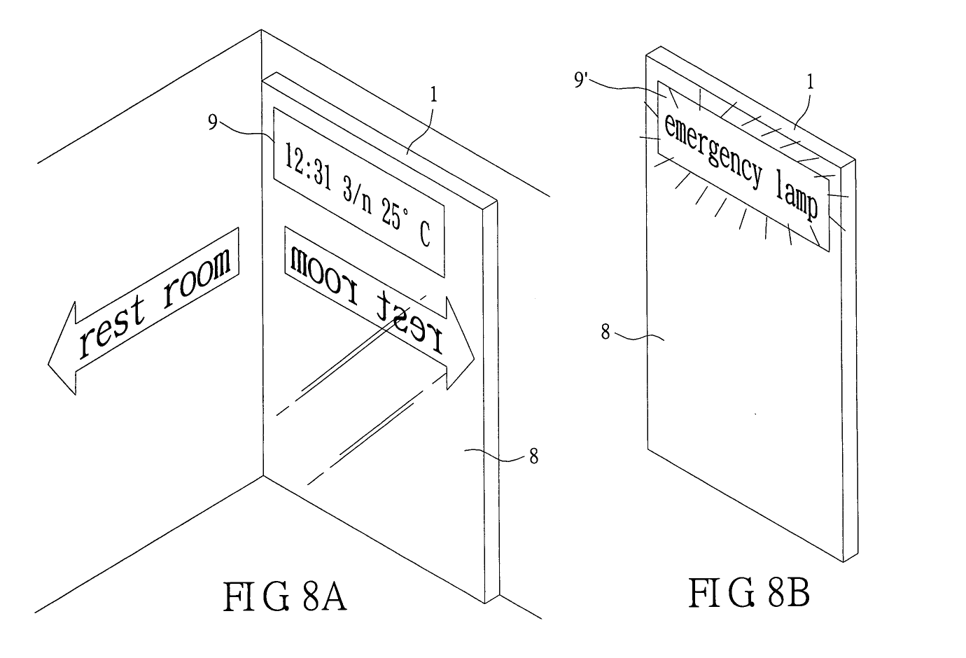

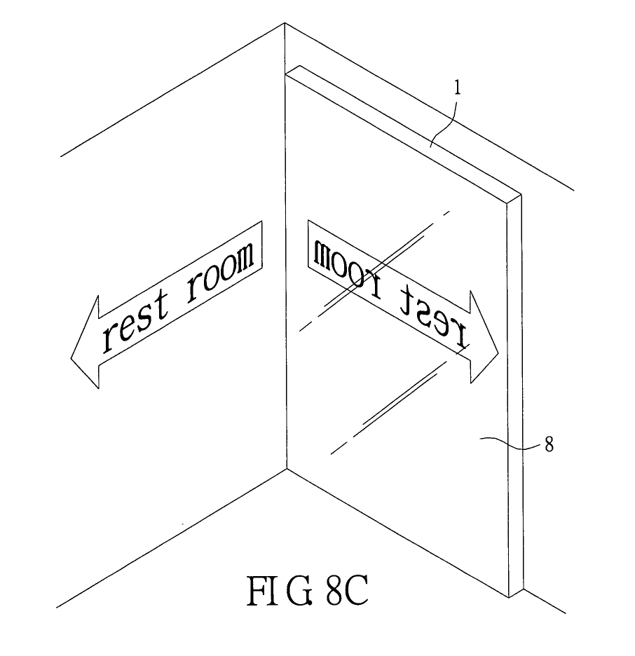

Reference is made to FIG. 8A, which shows a perspective view of the mirror having a field emission information display of the present invention with a displaying function. The user can apply make up or get dressed in front of a mirror surface 8 located on the semitransmitting reflecting mirror body 1, and can also simultaneously obtain information (such as the time, current news, or general information, etc.) from a lighting display image area 9 on the semitransmitting reflecting mirror body 1.

Reference is made to FIG. 8B, which shows a perspective view of the mirror having a field emission information display of the present invention with another displaying function. The field emission unit 2 of the mirror with a field emission information display generates a lighting area 9′ on the surface of the semitransmitting reflecting mirror body 1. The lighting area 9′ can be used in specified situations (such as, when the power is cut, or as an emergency exit light).

Reference is made to FIG. 8C, which shows a perspective view of the mirror having a field emission information display of the present invention without a displaying function. The surface of the semitransmitting reflecting mirror body 1 is a mirrored surface 8. The user can get dressed in front of the mirror

The mirror having a field emission information display of the present invention integrates the anode structure 21 and the cathode structure 22 of the field emission unit 2 with the semitransmitting reflecting mirror body 1, and is controlled by the control unit 3. The mirror having a field emission information display of the present invention has the following characteristics:

1. The mirror having a field emission information display provides the functions of a mirror and can also display information.

2. The brightness of the displayed information is larger than 300 cd/m².

3. The information image is detailed and colorful.

4. When the display area is active, the mirror having a field emission information display provides functions of a night light, an emergency light, or an information displayer. When the display area is inactive, the mirror having a field emission information display can also use the mirror as a normal mirror which can be used when getting dressed or applying cosmetics.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A mirror having a field emission information display, comprising:
a semitransmitting reflecting mirror body;
a field emission unit installed in the semitransmitting reflecting mirror body, wherein the field emission unit comprises an anode structure, a cathode structure corresponding to the anode structure, and an insulating structure located between the anode structure and the cathode structure to form a specified gap, wherein the anode structure comprises an anode conducting layer, and an anode layer located above the anode conducting layer, and the cathode structure has a cathode conducting layer, and a cathode layer located above the cathode conducting layer; and
a control unit installed in the semitransmitting reflecting mirror body, wherein the control unit is connected with the field emission unit for controlling the field emission unit to display information;
thereby, the field emission unit is controlled by the control unit so as to generate a plate lighting display image area or a lighting area on the semitransmitting reflecting mirror body.

2. The mirror having a field emission information display as claimed in claim 1, wherein the anode layer is a fluorescent layer, and the cathode layer is an emission layer.

3. The mirror having a field emission information display as claimed in claim 2, wherein the cathode layer is a carbon nanotube layer or a tiny metal pointed layer.

4. The mirror having a field emission information display as claimed in claim 1, wherein the cathode layer is a carbon nanotube layer formed by coating or screen printing by electrophoresis.

5. The mirror having a field emission information display as claimed in claim 1, wherein the thickness of the anode layer is within a specified range and the thickness of the anode layer is between 2˜10 μm, and the thickness of the cathode layer is within a specified range and the thickness of the cathode layer is between 1˜20 μm.

6. The mirror having a field emission information display as claimed in claim 1, wherein the anode layer is connected with an AC power to provide the power required for the field emission unit.

7. The mirror having a field emission information display as claimed in claim 6, wherein the AC power is a high frequency and high voltage AC power.

8. The mirror having a field emission information display as claimed in claim 1, wherein the anode structure further combines with a reflecting layer, and the reflecting layer is located at one side of the anode structure that is opposite to the anode conducting layer.

9. The mirror having a field emission information display as claimed in claim 8, wherein the reflecting layer is implemented by combining a metal material with the anode structure via an evaporation method.

10. The mirror having a field emission information display as claimed in claim 9, wherein the metal material is aluminum.

11. The mirror having a field emission information display as claimed in claim 8, wherein the reflecting layer is combined with the anode structure via a pasting-film method.

12. The mirror having a field emission information display as claimed in claim 1, wherein the control unit comprises a driving circuit module.

13. The mirror having a field emission information display as claimed in claim 1, wherein the control unit comprises a power circuit module.

14. The mirror having a field emission information display as claimed in claim 1, wherein the control unit comprises a feedback circuit module.
